(19) United States
(12) Patent Application Publication
(10) Pub. No.: US 2008/0160943 A1
(43) Pub. Date: Jul. 3, 2008

(54) METHOD AND APPARATUS TO POST-PROCESS AN AUDIO SIGNAL

(75) Inventors: Ho-young Sung, Suwon-si (KR); Jae-cheol Lee, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/755,086

(22) Filed: May 30, 2007

(30) Foreign Application Priority Data
Dec. 27, 2006 (KR) 2006-134984

(51) Int. Cl. H04B 1/16

(52) U.S. Cl. 455/205

(57) ABSTRACT

A method and apparatus to post process an audio signal. The method includes selecting one of a plurality of audio signal processing modes classified based on at least one of timbre, sound intensity, and rhythm of the audio signal, and modifying at least one of the timbre, the sound intensity, and the rhythm of the audio signal based on the selected audio signal processing mode.

### CROSS-REFERENCE TO RELATED APPLICATIONS

This application claims priority under 35 U.S.C. §119(a) from Korean Patent Application No. 10-2006-0134984, filed on Dec. 27, 2006, in the Korean Intellectual Property Office, the disclosure of which is incorporated herein in its entirety by reference.

### BACKGROUND OF THE INVENTION

1. Field of the Invention

The present general inventive concept relates to a method and apparatus to post-process an audio signal.

2. Description of the Related Art

Music has been classified using genre information (classic, jazz, rock, etc.) which is provided by producers, and most sound reproduction devices have adopted equalizer filters which are based on genre classification. The equalizer filters allow sound reproduction devices to output an equalized audio signal corresponding to a selected genre by adjusting a frequency characteristic of an audio signal.

However, since a number of digital music sources is constantly increasing, thereby resulting in an enormous music database, audiences need various access methods to search for desired music. One of the access methods includes classifying music according to moods. Audio sensitivity has become an increasingly important element for customers, and thus, a large variety of sound effects of an audio signal is necessary.

Unlike conventional music classification methods, music classification according to moods considers not only the frequency characteristic but also timbre, sound intensity, and rhythm of an audio signal.

However, according to conventional equalizing methods, since only the frequency characteristic can be adjusted, an audio signal cannot be adjusted based on the music classification according to moods.

### SUMMARY OF THE INVENTION

The present general inventive concept provides a method and apparatus to post-process an audio signal, whereby an audio signal can be adjusted based on music classification according to moods.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept are achieved by providing a method of post-processing an audio signal, the method including selecting one of a plurality of audio signal processing modes classified based on at least one of timbre, sound intensity, and rhythm of the audio signal, and modifying at least one of the timbre, the sound intensity, and the rhythm of the audio signal based on the selected audio signal processing mode.

The modifying may include increasing or decreasing a sampling rate of the audio signal.

The modifying may include converting the audio signal to an audio signal of a frequency domain, moving a position of the audio signal of the frequency domain to a higher frequency band by a predetermined frequency, and amplifying audio signal energy contained in a predetermined frequency band of the moved audio signal.

The amplifying of the audio signal energy may include amplifying audio signal energy contained in a frequency band between 2 KHz and 3 KHz.

The modifying may include converting the audio signal to an audio signal of a frequency domain, moving a position of the audio signal of the frequency domain to a lower frequency band by a predetermined frequency, and reducing audio signal energy contained in a predetermined frequency band of the moved audio signal.

The reducing of the audio signal energy may include reducing audio signal energy contained in a frequency band between 2 KHz and 20 KHz.

The modifying may include converting the audio signal to an audio signal of a frequency domain, widening a dynamic range of the audio signal of the frequency domain, and amplifying audio signal energy contained in a predetermined frequency band of the audio signal whose dynamic range is widened.

The amplifying of the audio signal energy may include amplifying audio signal energy contained in a predetermined frequency band based on 80 Hz and a predetermined frequency band based on 5 KHz.

The modifying may include converting the audio signal to an audio signal of a frequency domain, narrowing a dynamic range of the audio signal of the frequency domain, and amplifying audio signal energy contained in a predetermined frequency band of the audio signal whose dynamic range is narrowed.

The amplifying of the audio signal energy may include amplifying audio signal energy contained in a frequency band between 6 KHz and 20 KHz.

The foregoing and/or other aspects and utilities of the present general inventive concept may also be achieved by providing an apparatus to post-process an audio signal, the apparatus including a mode selector to select one of a plurality of audio signal processing modes classified based on at least one of timbre, sound intensity, and rhythm of the audio signal, and a processing unit to modify at least one of the timbre, the sound intensity, and the rhythm of the audio signal based on the selected audio signal processing mode.

The foregoing and/or other aspects and utilities of the present general inventive concept may also be achieved by providing a computer readable recording medium storing a computer readable program to execute a method of post-processing an audio signal, the method including selecting one of a plurality of audio signal processing modes classified based on at least one of timbre, sound intensity, and rhythm of the audio signal, and modifying at least one of the timbre, the sound intensity, and the rhythm of the audio signal based on the selected audio signal processing mode.

The foregoing and/or other aspects and utilities of the present general inventive concept may also be achieved by providing an apparatus to post-process an audio signal, the apparatus including a mode selector to select one of a plurality of audio signal processing modes based on a plurality of different human emotions, and a processing unit to modify at least one of a frequency, a dynamic range, and a sampling rate of the audio signal based on the selected audio signal processing mode.

The plurality of different human emotions may include at least one of exuberance, depression, anxiety, and contentment.

The processing unit may move a position of the audio signal to a higher frequency band and amplify the audio signal when the audio signal processing mode corresponding to the human emotion of exuberance is selected.

The processing unit may amplify audio signal energy contained in a frequency band between 2 KHz and 3 KHz.

The processing unit may move a position of the audio signal to a lower frequency band and reduce the audio signal when the audio signal processing mode corresponding to the human emotion of depression is selected.

The processing unit may amplify audio signal energy contained in a frequency band between 2 KHz and 20 KHz.

The processing unit may widen a dynamic range of the audio signal and amplify the audio signal when the audio signal processing mode corresponding to the human emotion of anxiety is selected.

The processing unit may amplify audio signal energy contained in a frequency band between 80 KHz and 5 KHz.

The processing unit may narrow a dynamic range of the audio signal and amplify the audio signal when the audio signal processing mode corresponding to the human emotion of contentment is selected.

The processing unit may amplify audio signal energy contained in a frequency band between 6 KHz and 20 KHz.

The plurality of human emotions may include at least one of happiness, sadness, restlessness, and serenity.

The audio signal processing modes may be based on the Thayer mood model.

The foregoing and/or other aspects and utilities of the present general inventive concept may also be achieved by providing an apparatus to post-process an audio signal, the apparatus including a mode selector to select one of a plurality of audio signal processing modes based on at least one of timbre, sound intensity, and rhythm of the audio signal, and a processing unit to adjust at least one of a frequency, a dynamic range, and a sampling rate of the audio signal based on the selected audio signal processing mode.

The processing unit may move a position of the audio signal to a higher frequency band and amplify the audio signal in a first mode.

The processing unit may move a position of the audio signal to a lower frequency band and reduce the audio signal in a second mode.

The processing unit may widen a dynamic range of the audio signal and amplify the audio signal in a third mode.

The processing unit may narrow a dynamic range of the audio signal and amplify the audio signal in a fourth mode.

The foregoing and/or other aspects and utilities of the present general inventive concept may also be achieved by providing a method of post-processing an audio signal, the method comprising selecting one of a plurality of audio signal processing modes based on a plurality of different human emotions, and modifying at least one of a frequency, a dynamic range, and a sampling rate of the audio signal based on the selected audio signal processing mode.

The plurality of different human emotions may include at least one of exuberance, depression, anxiety, and contentment.

The foregoing and/or other aspects and utilities of the present general inventive concept may also be achieved by providing a method of post-processing an audio signal, the method including selecting one of a plurality of audio signal processing modes based on at least one of timbre, sound intensity, and rhythm of the audio signal, and adjusting at least one of a frequency, a dynamic range, and a sampling rate of the audio signal based on the selected audio signal processing mode.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a block diagram of an apparatus to post-process an audio signal according to an embodiment of the present general inventive concept;

FIG. 2 is a diagram illustrating the Thayer mood model;

FIG. 3 is a table illustrating physical properties of processing modes and processing methods thereof according to an embodiment of the present general inventive concept;

FIG. 4 is a diagram illustrating an audio signal whose position is moved to a higher frequency band according to an embodiment of the present general inventive concept;

FIG. 5 is a diagram illustrating a characteristic of a filter used by a processing unit in a first processing mode according to an embodiment of the present general inventive concept;

FIG. 6 is a diagram illustrating an audio signal whose position is moved to a lower frequency band according to an embodiment of the present general inventive concept;

FIG. 7 is a diagram illustrating a characteristic of a filter used by a processing unit in a second processing mode according to an embodiment of the present general inventive concept;

FIG. 8 is a diagram illustrating an audio signal whose dynamic range is widened according to an embodiment of the present general inventive concept;

FIG. 9 is a diagram illustrating a characteristic of a filter used by a processing unit in a third processing mode according to an embodiment of the present general inventive concept;

FIG. 10 is a diagram illustrating a method of generating an audio signal having a slow-tempo rhythm in a fourth processing mode according to an embodiment of the present general inventive concept;

FIG. 11 is a diagram illustrating an audio signal whose dynamic range is narrowed according to an embodiment of the present general inventive concept; and

FIG. 12 is a diagram illustrating a characteristic of a filter used by a processing unit in a fourth processing mode according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

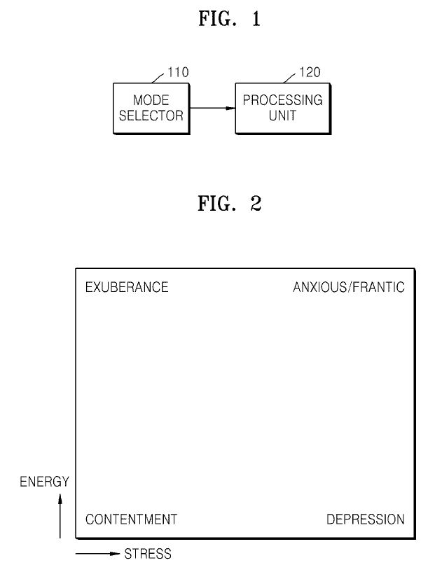

FIG. 1 is a block diagram of an apparatus to post-process an audio signal according to an embodiment of the present general inventive concept.

Referring to FIG. 1, the apparatus includes a mode selector 110 and a processing unit 120.

The mode selector 110 selects one of a plurality of processing modes of the audio signal, which can be classified based on timbre, sound intensity, and rhythm of the audio signal. However, the processing modes are not limited thereto, and can include other processing modes of an audio signal.

One of the plurality of processing modes can be selected when a user inputs a signal to select a predetermined processing mode using an input unit.

In the current embodiment, four processing modes are supported, where each processing mode defines physical properties, such as the timbre, the sound intensity, and the rhythm of the audio signal, in order to provide four sound sensations which are based on human emotions. The physical properties of each processing mode are set based on the Thayer mood model.

FIG. 2 is a diagram illustrating the Thayer mood model.

The Thayer mood model defines the four processing modes by analyzing how stress and energy influence human emotions. That is, when a listener listens to music having a high energy level, an amount of epinephrine which is secreted in the listener's brain increases, and thus, the listener experiences both a desire to move or be active and a feeling of exuberance. Accordingly, the listener may be moved to sing, beat time, or dance along the music. In contrast, music having a high stress level causes a listener's brain to secrete cortisol, which is commonly known as a hormone associated with stress. Accordingly, the listener may experience an unstable emotion, such as depression or anxiety.

Thayer defined the four processing modes using the correlations described above, wherein a first mode represents “exuberance”, a second mode “depression”, a third mode “anxious/frantic”, and a fourth mode “contentment”.

The first mode representing “exuberance” is a mode which is set to represent a pleasantly-energetic and joyful (i.e., happy) emotion. An audio signal in the “exuberance” mode is in a state of low stress and high energy. Therefore, the “exuberance” mode can be noisy and vigorous due to dynamic and high energy qualities of the audio signal, but can still exude a low level of stress on a listener due to a low level of stress qualities of the audio signal. An example of music providing the emotion of the first mode is Rossini's “William Tell Overture.”

The second mode representing “depression” is a mode which is set to represent a calm and somewhat sad emotion. An audio signal in the “depression” mode is in a state of high stress and low energy. An example of music providing the emotion of the second mode is Stravinsky's “Firebird.”

The third mode representing “anxious/frantic” is a mode which is set to represent an eruptive and frenzied emotion (e.g., restlessness). An audio signal in the “anxious/frantic” mode is in a state of high stress and high energy. An example of music providing the emotion of the third mode is Berg's “Lulu.” In addition, general “rock,” heavy-metal,” and “punk” music correspond to the third mode.

The fourth mode representing “contentment” is a mode which is set to represent a very joyful, serene, and positive emotion. An audio signal in the “contentment” mode is in a state of low stress and low energy. An example of music providing the emotion of the fourth mode is Bach's “Jesus, Joy of Man's Desire.”

Each of the four processing modes can be defined by the physical properties mentioned above, such as a tone (a major or a minor), timbre, sound intensity, and rhythm of an audio signal. In this embodiment, tone will be excluded due to difficulty in tone identification. Therefore, in the present embodiment, each of the four modes is defined using the three properties mentioned above, excluding the tone, and processing is performed according to a selected mode.

The timbre and the rhythm of the audio signal are related to the stress level, and the sound intensity of the audio signal is related to the energy level. The sound intensity uses Root Mean Square (RMS) power to form the audio signal, where high sound intensity makes the sound heard high, and low sound intensity makes the sound heard low. The timbre indicates whether a sound produced by the audio signal is bright or heavy, or whether a sound pitch is high or low. The rhythm indicates whether a tempo of the audio signal is quick or slow, or whether strength of a sound produced by the audio signal is strong or weak.

The processing unit 120 of FIG. 2 can modify, for example, the timbre, the sound intensity, and the rhythm of the audio signal based on the selected processing mode. The audio signal may be output in real-time through a radio or other media player. In addition, the audio signal can be in a stored file, such as an mp3 file, to be output at a later time by a media player.

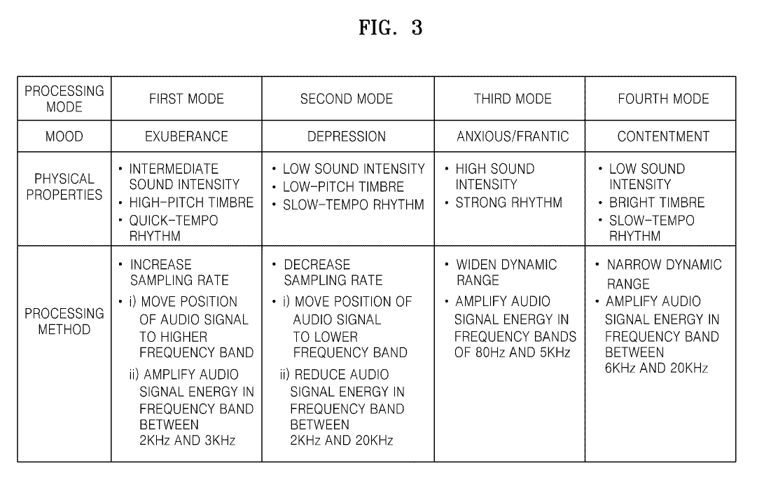

An operation of the processing unit 120 will now be described in detail with reference to FIGS. 3 through 11.

FIG. 3 is a table illustrating physical properties of processing modes and processing methods thereof according to an embodiment of the present general inventive concept.

Referring to FIG. 3, a first processing mode is a mode representing “exuberance,” and is set to process an audio signal to have intermediate sound intensity, high-pitch timbre, and a quick-tempo rhythm.

The processing unit 120 of FIG. 2 has two processing methods to implement the physical properties set as the first processing mode, wherein one is a processing method in a time domain, and the other is a processing method in a frequency domain.

In the time domain, the processing unit 120 increases a sampling rate of the audio signal. The sampling rate is a rate of converting a sound to samples corresponding to 1 second. For example, a sampling rate of 44.1 KHz means that a sound is sampled 44100 times for 1 second. An increase of the sampling rate means that more samples are obtained for 1 second. Why the sampling rate is increased is because an increase of the sampling rate results in high-pitch timbre and a quick tempo.

However, the method of increasing the sampling rate cannot be applied to an audio signal which is output in real-time, but can be applied to a stored audio signal, such as an mp3 file.

In the frequency domain, the processing unit 120 moves a position of the audio signal to a higher frequency band and amplifies audio signal energy corresponding to a frequency band between 2 KHz and 3 KHz.

FIG. 4 is a diagram illustrating an audio signal whose position is moved to a higher frequency band according to an embodiment of the present general inventive concept.

In FIG. 4, an original audio signal 410 assumed as a sine wave and an audio signal 420, which is obtained by moving a position of the original audio signal 410, are illustrated. The audio signal 420 can be obtained by multiplying a frequency of the original audio signal 410 by 2.

Accordingly, a signal located at 20 Hz is moved to 40 Hz, and a signal located at 1 KHz is moved to 2 KHz. That is, if an audio signal is moved to a higher frequency band, the audio signal has high-pitch timbre.

However, the method of moving a frequency band is not limited thereto. That is, all methods which can move a frequency band can be used.

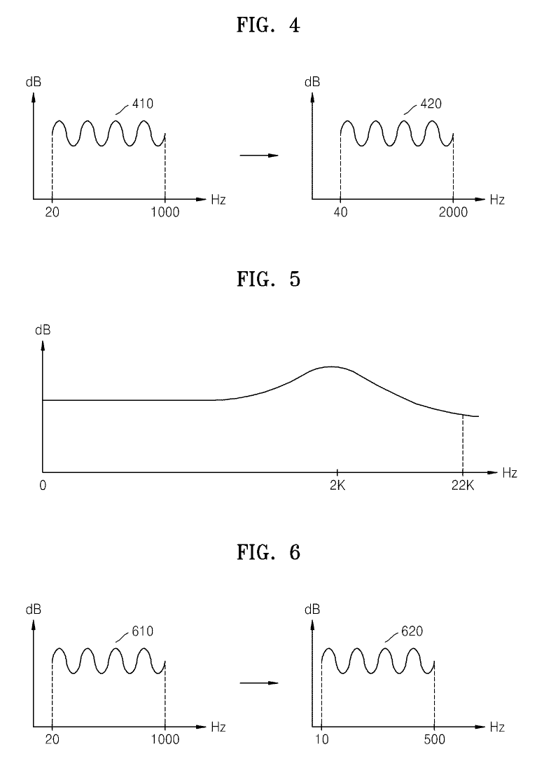

FIG. 5 is a diagram illustrating a characteristic of a filter which is used by the processing unit 120 of FIG. 2 in the first processing mode of FIG. 3, according to an embodiment of the present general inventive concept.

FIG. 5 illustrates a graph in which a function value gradually decreases based on 2 KHz. If an audio signal is filtered using the filter in the first processing mode, as illustrated in FIG. 5, energy of the audio signal in the frequency band between 2 KHz and 3 KHz can be increased.

Referring back to FIG. 3, a second processing mode is a mode representing “depression,” and is set to process an audio signal to have low sound intensity, low-pitch timbre, and a slow-tempo rhythm.

Like in the first processing mode, the processing unit 120 has two processing methods to implement the physical properties in the second processing mode, wherein one is a processing method in the time domain, and the other is a processing method in the frequency domain.

In the time domain, the processing unit 120 decreases a sampling rate of the audio signal. The sampling rate is decreased because a decrease of the sampling rate results in low-pitch timbre and a slow tempo.

However, the method of decreasing the sampling rate cannot be applied to an audio signal which is output in real-time, but can be applied to a stored audio signal, such as an mp3 file.

In the frequency domain, the processing unit 120 moves a position of the audio signal to a lower frequency band and reduces audio signal energy corresponding to a frequency band between 2 KHz and 20 KHz. The movement and the reduction operations of the audio signal may be performed in any order.

FIG. 6 is a diagram illustrating an audio signal whose position is moved to a lower frequency band according to an embodiment of the present general inventive concept.

In FIG. 6, an original audio signal 610 which is represented by a sine wave and an audio signal 620 which is obtained by moving a position of the original audio signal 610 are illustrated. The audio signal 620 can be obtained by multiplying a frequency of the original audio signal 610 by 0.5.

Accordingly, a signal which located at 20 Hz is moved to 10 Hz, and a signal located at 1 KHz is moved to 500 Hz. That is, if an audio signal is moved to a lower frequency band, the audio signal has low-pitch timbre.

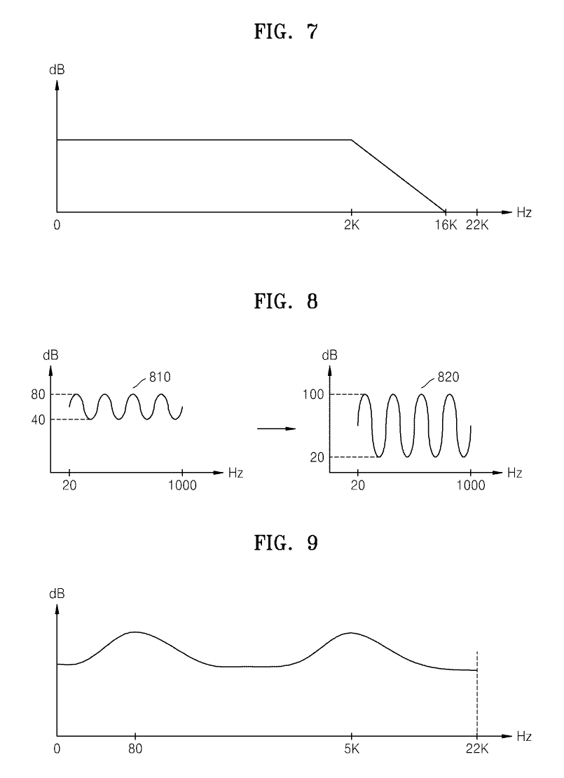

FIG. 7 is a diagram illustrating a characteristic of a filter used by the processing unit 120 of FIG. 2 in the second processing mode of FIG. 3, according to an embodiment of the present general inventive concept.

FIG. 7 illustrates a graph in which a function value in the frequency band between 2 KHz and 20 KHz gradually decreases according to an increase of a frequency. If an audio signal is filtered using the filter in the second processing mode, as illustrated in FIG. 7, energy of the audio signal in the frequency band between 2 KHz and 20 KHz can be decreased.

Referring back to FIG. 3, a third processing mode is a mode representing an “anxious/frantic” emotion, and is set to process an audio signal to have high sound intensity and a strong rhythm.

In order to implement the physical properties set as the third processing mode, the processing unit 120 widens a dynamic range of the audio signal and amplifies audio signal energy corresponding to frequency bands around 80 Hz and 5 KHz. The widening and the amplification operations of the audio signal may be performed in any order.

FIG. 8 is a diagram illustrating an audio signal whose dynamic range is widened according to an embodiment of the present general inventive concept.

The dynamic range is a range between a function value in which energy of an audio signal is maximized and a function value in which the energy of the audio signal is minimized. In FIG. 8, although a dynamic range of an original audio signal 810 is between 40 dB and 80 dB, the processing unit 120 of FIG. 2 widens the dynamic range to a range between 20 dB and 100 dB as illustrated by a widened audio signal 820. If the dynamic range is widened, an entire energy level can be increased while maintaining musical quality.

FIG. 9 is a diagram illustrating a characteristic of a filter which is used by the processing unit 120 of FIG. 2 in the third processing mode of FIG. 3, according to an embodiment of the present general inventive concept.

FIG. 9 illustrates a graph in which magnitudes of function values in frequency bands around 80 Hz and 5 KHz are relatively greater. If an audio signal is filtered using the filter in the third processing mode, as illustrated in FIG. 9, energy of the audio signal in the frequency bands around 80 Hz and 5 KHz can be increased.

Referring back to FIG. 3, a fourth processing mode is a mode representing “contentment,” and is set to process an audio signal to have physical properties of low sound intensity, bright timbre, and a slow-tempo rhythm.

In order to implement the physical properties set as the fourth processing mode, the processing unit 120 narrows a dynamic range of the audio signal and) amplifies audio signal energy corresponding to a frequency band between 6 KHz and 20 KHz. The narrowing and the amplification operations of the audio signal may be performed in any order.

In addition, the processing unit 120 can implement a low-tempo rhythm in a method of reducing a time domain of the audio signal processed by the narrowing and amplification operations of the audio signal using a Time Domain Pitch Synchronous Overlap-Add (TD-PSOLA) method. However, the TD-PSOLA method cannot be applied to an audio signal which is output in real-time, but can be applied to a stored audio signal, such as an mp3 file.

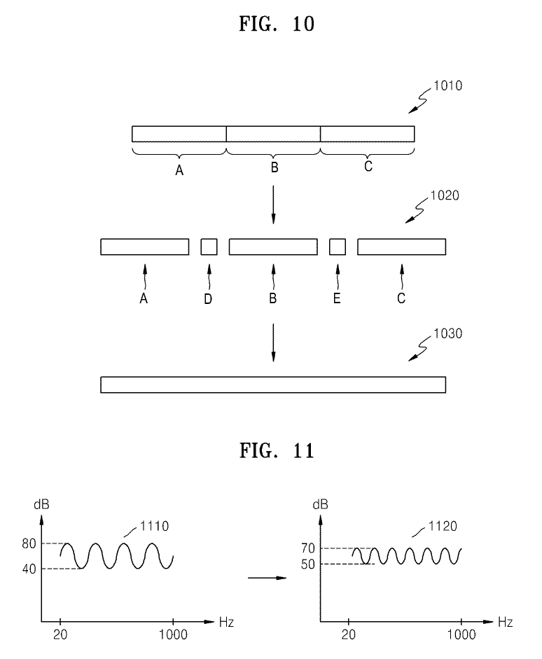

FIG. 10 is a diagram illustrating a method of generating an audio signal having a slow-tempo rhythm in the fourth processing mode of FIG. 3, according to an embodiment of the present general inventive concept.

FIG. 10 is a diagram illustrating a schematic concept of the TD-PSOLA method and illustrates a method of decreasing tempo speed by processing an audio signal having a reproduction time of 3 minutes to have a reproduction time of 4 minutes.

Referring to FIG. 10, in the time domain, an entire duration of an audio signal is divided into 3 time durations A, B, and C (as denoted by reference number 1010). Two time durations D and E are added to the 3 time durations A, B, and C (as denoted by reference number 1020). The two additional time durations D and E can be added using a mean value of the audio signal or a value which is obtained by copying an audio signal before each of the additional time durations are added. An audio signal having a reproduction time of 4 minutes is generated by synthesizing the five time durations (as denoted by reference number 1030).

Since the TD-PSOLA method is well known to one of ordinary skill in the art, a detailed description thereof is omitted.

FIG. 11 is a diagram illustrating an audio signal whose dynamic range is narrowed according to an embodiment of the present general inventive concept.

In FIG. 11, although a dynamic range of an original audio signal 1110 is between 40 dB and 80 dB, the processing unit 120 reduces the dynamic range to a range between 50 dB and 70 dB illustrated by a narrowed audio signal 1120. If a dynamic range is narrowed, an entire energy level can be decreased due to a decrease of an alteration range of the audio signal.

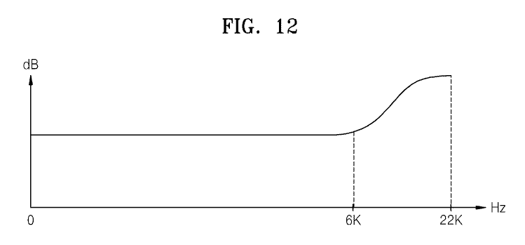

FIG. 12 is a diagram illustrating a characteristic of a filter used by the processing unit 120 of FIG. 2 in the fourth processing mode of FIG. 3, according to an embodiment of the present general inventive concept.

FIG. 12 illustrates a graph in which a function value in a frequency band above 6 KHz gradually increases according to an increase of a frequency. If an audio signal is filtered using the filter in the fourth processing mode, as illustrated in FIG. 12, energy of the audio signal in the frequency band above 6 KHz can be increased, resulting in bright timbre of the audio signal.

The present general inventive concept can also be embodied as computer-readable codes on a computer-readable medium. The computer-readable medium can include a computer-readable recording medium and a computer-readable transmission medium. The computer-readable recording medium is any data storage device that can store data which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

As described above, according to the present general inventive concept, by modifying timbre, sound intensity, and rhythm of an audio signal, based on audio signal processing modes which are classified based on the timbre, the sound intensity, and the rhythm of the audio signal, the audio signal can be adjusted based on music classification according to moods.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A method of post-processing an audio signal, the method comprising:
selecting one of a plurality of audio signal processing modes classified based on at least one of timbre, sound intensity, and rhythm of the audio signal; and
modifying at least one of the timbre, the sound intensity, and the rhythm of the audio signal based on the selected audio signal processing mode.

2. The method of claim 1, wherein the modifying comprises increasing or decreasing a sampling rate of the audio signal.

3. The method of claim 1, wherein the modifying comprises:
converting the audio signal to an audio signal of a frequency domain;
moving a position of the audio signal of the frequency domain to a higher frequency band by a predetermined frequency; and
amplifying audio signal energy contained in a predetermined frequency band of the moved audio signal.

4. The method of claim 3, wherein the amplifying of the audio signal energy comprises amplifying audio signal energy contained in a frequency band between 2 KHz and 3 KHz.

5. The method of claim 1, wherein the modifying comprises:
converting the audio signal to an audio signal of a frequency domain;
moving a position of the audio signal of the frequency domain to a lower frequency band by a predetermined frequency; and
reducing audio signal energy contained in a predetermined frequency band of the moved audio signal.

6. The method of claim 5, wherein the reducing of the audio signal energy comprises reducing audio signal energy contained in a frequency band between 2 KHz and 20 KHz.

7. The method of claim 1, wherein the modifying comprises:
converting the audio signal to an audio signal of a frequency domain;
widening a dynamic range of the audio signal of the frequency domain; and
amplifying audio signal energy contained in a predetermined frequency band of the audio signal whose dynamic range is widened.

8. The method of claim 7, wherein the amplifying of the audio signal energy comprises amplifying audio signal energy contained in a predetermined frequency band based on 80 Hz and a predetermined frequency band based on 5 KHz.

9. The method of claim 1, wherein the modifying comprises:
converting the audio signal to an audio signal of a frequency domain;
narrowing a dynamic range of the audio signal of the frequency domain; and
amplifying audio signal energy contained in a predetermined frequency band of the audio signal whose dynamic range is narrowed.

10. The method of claim 9, wherein the amplifying of the audio signal energy comprises amplifying audio signal energy contained in a frequency band between 6 KHz and 20 KHz.

11. An apparatus to post-process an audio signal, the apparatus comprising:
a mode selector to select one of a plurality of audio signal processing modes classified based on at least one of timbre, sound intensity, and rhythm of the audio signal; and
a processing unit to modify at least one of the timbre, the sound intensity, and the rhythm of the audio signal based on the selected audio signal processing mode.

12. The apparatus of claim 11, wherein the processing unit increases or decreases a sampling rate of the audio signal.

13. The apparatus of claim 11, wherein the processing unit converts the audio signal to an audio signal of a frequency domain, moves a position of the audio signal of the frequency domain to a higher frequency band by a predetermined frequency, and amplifies audio signal energy contained in a predetermined frequency band of the moved audio signal.

14. The apparatus of claim 13, wherein the processing unit amplifies audio signal energy contained in a frequency band between 2 KHz and 3 KHz.

15. The apparatus of claim 11, wherein the processing unit converts the audio signal to an audio signal of a frequency domain, moves a position of the audio signal of the frequency domain to a lower frequency band by a predetermined frequency, and reduces audio signal energy contained in a predetermined frequency band of the moved audio signal.

16. The apparatus of claim 15, wherein the processing unit reduces audio signal energy contained in a frequency band between 2 KHz and 20 KHz.

17. The apparatus of claim 11, wherein the processing unit converts the audio signal to an audio signal of a frequency domain, widens a dynamic range of the audio signal of the frequency domain, and amplifies audio signal energy contained in a predetermined frequency band of the audio signal whose dynamic range is widened.

18. The apparatus of claim 17, wherein the processing unit amplifies audio signal energy contained in a predetermined frequency band based on 80 Hz and a predetermined frequency band based on 5 KHz.

19. The apparatus of claim 11, wherein the processing unit converts the audio signal to an audio signal of a frequency domain, narrows a dynamic range of the audio signal of the frequency domain, and amplifies audio signal energy contained in a predetermined frequency band of the audio signal whose dynamic range is narrowed.

20. The apparatus of claim 19, wherein the processing unit amplifies audio signal energy contained in a frequency band between 6 KHz and 20 KHz.

21. A computer readable recording medium having embodied thereon a computer program to execute a method, wherein the method comprises:
selecting one of a plurality of audio signal processing modes classified based on at least one of timbre, sound intensity, and rhythm of the audio signal; and
modifying at least one of the timbre, the sound intensity, and the rhythm of the audio signal based on the selected audio signal processing mode.

22. An apparatus to post-process an audio signal, the apparatus comprising:
a mode selector to select one of a plurality of audio signal processing modes based on a plurality of different human emotions; and
a processing unit to modify at least one of a frequency, a dynamic range, and a sampling rate of the audio signal based on the selected audio signal processing mode.

23. The apparatus of claim 22, wherein the plurality of different human emotions comprise at least one of exuberance, depression, anxiety, and contentment.

24. The apparatus of claim 23, wherein the processing unit moves a position of the audio signal to a higher frequency band and amplifies the audio signal when the audio signal processing mode corresponding to the human emotion of exuberance is selected.

25. The apparatus of claim 24, wherein the processing unit amplifies audio signal energy contained in a frequency band between 2 KHz and 3 KHz.

26. The apparatus of claim 23, wherein the processing unit moves a position of the audio signal to a lower frequency band and reduces the audio signal when the audio signal processing mode corresponding to the human emotion of depression is selected.

27. The apparatus of claim 26, wherein the processing unit reduces audio signal energy contained in a frequency band between 2 KHz and 20 KHz.

28. The apparatus of claim 23, wherein the processing unit widens a dynamic range of the audio signal and amplifies the audio signal when the audio signal processing mode corresponding to the human emotion of anxiety is selected.

29. The apparatus of claim 28, wherein the processing unit amplifies audio signal energy contained in bands around 80 Hz and 5 KHz.

30. The apparatus of claim 23, wherein the processing unit narrows a dynamic range of the audio signal and amplifies the audio signal when the audio signal processing mode corresponding to the human emotion of contentment is selected.

31. The apparatus of claim 30, wherein the processing unit amplifies audio signal energy contained in a frequency band between 6 KHz and 20 KHz.

32. The apparatus of claim 22, wherein the plurality of human emotions comprise at least one of happiness, sadness, restlessness, and serenity.

33. The apparatus of claim 22, wherein the audio signal processing modes are based on the Thayer mood model.

34. An apparatus to post-process an audio signal, the apparatus comprising:
a mode selector to select one of a plurality of audio signal processing modes based on at least one of timbre, sound intensity, and rhythm of the audio signal; and
a processing unit to adjust at least one of a frequency, a dynamic range, and a sampling rate of the audio signal based on the selected audio signal processing mode.

35. The apparatus of claim 34, wherein the processing unit moves a position of the audio signal to a higher frequency band and amplifies the audio signal in a first mode.

36. The apparatus of claim 34, wherein the processing unit moves a position of the audio signal to a lower frequency band and reduces the audio signal in a second mode.

37. The apparatus of claim 34, wherein the processing unit widens a dynamic range of the audio signal and amplifies the audio signal in a third mode.

38. The apparatus of claim 34, wherein the processing unit narrows a dynamic range of the audio signal and amplifies the audio signal in a fourth mode.

39. A method of post-processing an audio signal, the method comprising:
selecting one of a plurality of audio signal processing modes based on a plurality of different human emotions; and
modifying at least one of a frequency, a dynamic range, and a sampling rate of the audio signal based on the selected audio signal processing mode.

40. The method of claim 39, wherein the plurality of different human emotions comprise at least one of exuberance, depression, anxiety, and contentment.

41. A method of post-processing an audio signal, the method comprising:
selecting one of a plurality of audio signal processing modes based on at least one of timbre, sound intensity, and rhythm of the audio signal; and
adjusting at least one of a frequency, a dynamic range, and a sampling rate of the audio signal based on the selected audio signal processing mode.
